(19) United States
(12) Patent Application Publication
(10) Pub. No.: US 2015/0209719 A1
(43) Pub. Date: Jul. 30, 2015

(54) METHOD FOR REMOVING AROMATIC HYDROCARBONS FROM COKE OVEN GAS HAVING BIODIESEL AS WASHING LIQUID AND DEVICE FOR CARRYING OUT SAID METHOD

(71) Applicant: THYSSENKRUPP INDUSTRIAL SOLUTIONS AG, Essen (DE)

(72) Inventors: Diethmar Richter, Dortmund (DE); Holger Thielert, Dortmund (DE)

(73) Assignee: THYSSENKRUPP INDUSTRIAL SOLUTIONS AG, Essen (DE)

(21) Appl. No.: 14/420,588

(22) PCT Filed: Jul. 16, 2013
(86) PCT No.: PCT/EP2013/064964

§ 371 Date: Feb. 9, 2015

(30) Foreign Application Priority Data
Aug. 9, 2012 (DE) 20 2012 107 336.8

(51) Int. Cl. B01D 53/14

(52) U.S. Cl. CPC B01D 53/1493; B01D 53/1425; B01D 53/1406; B01D 53/1487; B01D 2252/205

(57) ABSTRACT

The invention relates to a process for removing aromatic hydrocarbons from coke oven gas (COG), in which biodiesel is conveyed in a circuit as scrubbing liquid. The coke oven gas (COG) is brought into contact with the biodiesel in a first gas scrubbing stage to separate off aromatic hydrocarbons. The biodiesel enriched in aromatic hydrocarbons is then taken off from the first gas scrubbing stage, heated and regenerated by stripping with steam. The biodiesel which has been regenerated by stripping is then, after cooling, fed back into the first gas scrubbing stage. According to the invention, the coke oven gas (COG) purified in the first gas scrubbing stage is fed to a further, second gas scrubbing stage to which a more highly stripped substream of the biodiesel is fed as scrubbing liquid.

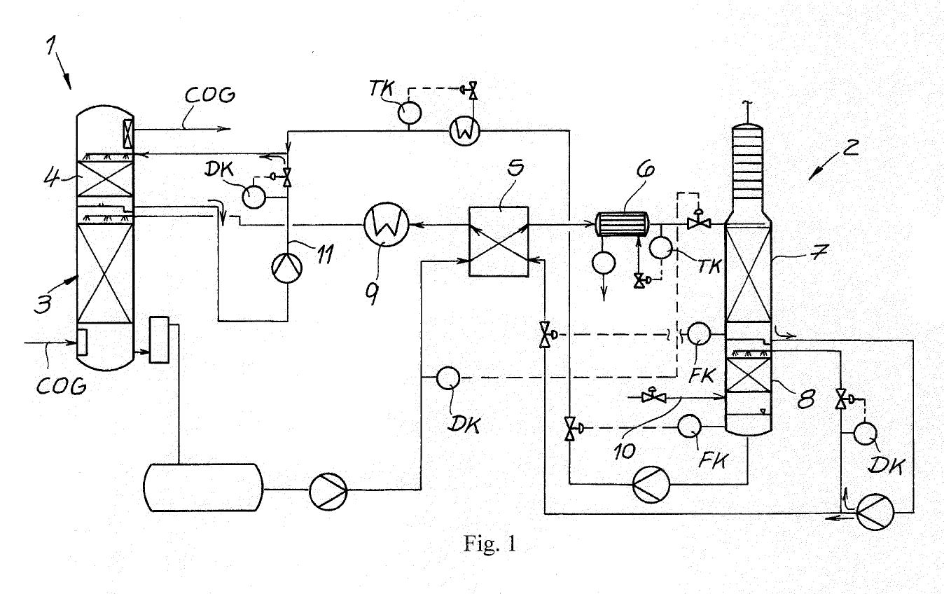

The present invention relates to a process for removing aromatic hydrocarbons from coke oven gas, in which biodiesel is conveyed as scrubbing liquid in a circuit, where the coke oven gas is brought into contact with the biodiesel in a first gas scrubbing stage and aromatic hydrocarbons are separated off from the coke oven gas by absorption, the biodiesel enriched in aromatic hydrocarbons is subsequently taken off from the first gas scrubbing stage, is heated and the aromatic hydrocarbons are partly driven off from the biodiesel by stripping with steam and the biodiesel which has been regenerated by stripping is, after cooling, fed at least partly back to the first gas scrubber. Also a subject of the invention is an apparatus for carrying out the process.

In the coking of coal, aromatic hydrocarbons are liberated as constituent of the coke oven gas formed. To be able to pass the aromatic hydrocarbons to a further use and not release them into the environment, they are usually scrubbed out of the coke oven gas after the removal of tar and ammonia in the work-up of the coke oven gas. In practice, a scrubbing oil based on a tar oil fraction produced in the processing of hard coal is used as scrubbing liquid. Due to the aromatic hydrocarbons mainly present, viz. benzene, toluene, m-, p-, o-xylene and ethylbenzene, this process step is generally also referred to as BTEX scrub, BTX scrub or benzene scrub. The aromatic hydrocarbons mentioned are collectively also referred to as crude benzene, with the proportion of crude benzene typically being in the range from 20 to 40 grams per standard cubic meter (standard m³), depending on the coal used for the coking process and the process conditions. The crude benzene typically comprises from 55 to 75% of benzene, from 13 to 19% of toluene and from 5 to 10% of xylenes. The coke oven gas additionally contains polycyclic aromatic hydrocarbons, in particular naphthalene, which can be taken up by the scrubbing oil to a certain extent. Furthermore, the coke oven gas contains impurities, in particular H₂S, HCN, NH₃ and organic sulfur compounds. A typical composition of a coke oven gas comprises, for example:
from 54 to 62% by volume of H₂
from 23 to 28% by volume of CH₄
from 6.2 to 8% by volume of CO
H₂S about 7 g/standard m³
HCN about 1.5 g/standard m³
NH₃ 7 g/standard m³
S_{ORG} about 0.5 g/standard m³
BTX up to 40 g/standard m³
naphthalene up to 2 g/standard m³

BTEX scrubbing processes have been used without changes in their basic principles for decades and are described, for example, in the specialist textbook O. Grosskinsky, “Handbuch des Kokereiwesens”, Volume 2, 1958 edition, pages 137 ff. The BTEX scrub is carried out in one or more scrubbers arranged in series, with intimate contact between the coke oven gas and the scrubbing oil as scrubbing liquid having to be ensured to effect absorption of the aromatic hydrocarbons by the scrubbing oil. Intimate contact can be achieved either by means of fine atomization of the scrubbing oil or by means of thin oil films

The combination of a sprinkling device with trays, packing elements or other internals, with the oil droplets coming from the sprinlding unit being spread out to form an oil film having a very large surface area, is particularly advantageous. The solubility of benzene, toluene and xylene is, in particular, dependent on the vapor pressure of the various components, for which reason the scrubbing oil is fed at comparatively low temperatures to the scrubber.

On the other hand, the scrubbing oil also has to have a sufficient flowability and low viscosity for it to be able to be distributed readily and be able to form a large surface area. The scrubbing oil enriched in aromatic hydrocarbons which collects at the bottom of the scrubber is taken off, and the crude benzene is subsequently driven off from the scrubbing oil at elevated temperature by stripping with steam. The scrubbing oil is then, after cooling, recirculated to the scrubber. In order to achieve substantial scrubbing-out of crude benzene at a very high throughput of coke oven gas, the scrubbing oil is introduced in excess into the scrubber. In order to be able to carry out the BTEX scrub at the amounts of coke oven gas obtained in modern coking plants, large amounts of scrubbing oil are required.

In the specialist article KUZIMINA E YA ET AL: “A NEW PETROLEUM WASH OIL TO RECOVER CRUDE BENZOL”, COKE AND CHEMISTRY U.S.S.R., No. 12, 1987, pages 45-49, it is proposed that fossil diesel oil be used as scrubbing liquid. However, it was established in corresponding experiments that during stripping with steam sticky residues having a rubber-like consistency are formed in the scrubbing oil and precipitated at the temperatures prevailing there. Diesel oil has therefore not been found to be useful as scrubbing liquid conveyed in a circuit.

A process having the above-described features is known from WO 2009/003 644 A1. In order to improve the absorption of aromatic hydrocarbons from coke oven gas in a BTEX scrub, the use of biodiesel as scrubbing liquid has been proposed. For the purposes of the present invention, the term “biodiesel” refers to an organic fuel which, in contrast to fossil diesel oil, is not obtained from fossil crude oil but instead from vegetable oils by transesterification.

Biodiesel is surprisingly a highly efficient scrub liquid by means of which the aromatic hydrocarbons benzene, toluene, m-, p-, o-xylene and ethylbenzene can be removed. Biodiesel is also inexpensive, able to be handled without problems and additionally has an improved CO₂ balance.

In addition to the absorption of the BTEX components, the proportion of the polycyclic aromatic hydrocarbon naphthalene is significantly reduced. In a process as described in WO 2009/003 644 A1, the naphthalene concentration can be reduced from an initial proportion of typically up to 2 g/standard m³ (gram per standard cubic meter) at conventional process parameters to a concentration of from 100 to 150 mg/standard m³ (milligram per standard cubic meter). At comparable operating parameters, significantly higher values in the range from 200 to 300 mg/standard m³ are obtained in the case of a conventional scrubbing liquid based on mineral oil or tar oil since these have, even in the fresh state, a considerable residual concentration of naphthalene.

Although biodiesel enables some removal of naphthalene, problems are also presented by the residual concentration left in the case of the process as described in WO 2009/003644 A1. On top of the deleterious properties of naphthalene on health and the environment, it can also form deposits in the pipeline system downstream of the BTEX scrub; as a result, the lines in question may become soiled or even clogged.

In the light of this background, it is an object of the present patent application to reduce the concentration of naphthalene in the purified coke oven gas further.

To achieve this object, the invention provides a process as claimed in claim 1 and an apparatus as claimed in claim 8 for carrying out the process.

The process of the invention is characterized in that the gas scrub is carried out in at least two stages, with the coke oven gas purified in a first gas scrubbing stage being, in order to effect further removal of naphthalene, conveyed through a second gas scrubbing stage to which a first substream of the regenerated biodiesel, which is more highly stripped compared to a second substream which is fed to the first scrubbing stage, is fed.

Even in the first gas scrubbing stage, biodiesel is usually introduced in excess as scrubbing liquid, as also in the process known from WO 2009/003 644 A1. That is to say, the absorption capacity of the biodiesel is selected so that the BTEX components can be largely removed. However, the actual removal of the aromatic hydrocarbons depends on the phase equilibrium of the individual materials in the gas phase and liquid phase and also on the intimate contact of the scrubbing liquid with the coke oven gas.

The present invention is based on the recognition that the parameters which are preferred for a BTEX scrub for practical and economic reasons make only limited removal of naphthalene possible. In particular, it has to be taken into account that in the regeneration, the stripping of the aromatic hydrocarbons by means of steam is incomplete; here too, the thermodynamic equilibria during the regeneration process have to be taken into account. In the case of naphthalene in particular, it has to be noted that the scrubbing liquid which has been regenerated under conventional conditions has a considerable residual concentration, so that the removal of naphthalene during the gas scrub is accordingly limited, in particular at elevated temperatures.

In the light of this background, a substream of the biodiesel as scrubbing liquid is more highly stripped by means of a further regeneration step, especially for the removal of naphthalene.

According to the invention, the concentration of naphthalene can be reduced to a concentration of less than 50 mg/standard m³ in the gas scrub of the coke oven gas, starting out from the normal composition of coke oven gas.

According to a preferred development of the invention, the biodiesel introduced as scrubbing liquid into the second gas scrubbing stage is, after contacting with the coke oven gas which has previously already been purified in the first gas scrubbing stage, partly taken off from the second gas scrubbing stage and, without regeneration, reintroduced into the second gas scrubbing stage and thus conveyed in a circuit. Thus, a separate circuit of stripped biodiesel is made available for the second gas scrubbing stage. Excessive accumulation of naphthalene in this additional circuit is thus avoided by a first, highly stripped substream of the regenerated biodiesel always being fed in. The highly stripped biodiesel can also be referred to as ultra lean oil, which can, in particular, be obtained in a separate regeneration stage.

In the second gas scrubbing stage, after contacting with the coke oven gas, a further, uncirculated part of the biodiesel enriched in naphthalene can be introduced into the first scrubbing stage for further enrichment with aromatic hydrocarbons. The transfer of this further part of biodiesel is advantageously effected directly, i.e. without further treatment. In particular, the first gas scrubbing stage and the second gas scrubbing stage can be present in a joint gas scrubbing column, with the second gas scrubbing stage being arranged above the first gas scrubbing stage. In such an embodiment, the first highly stripped substream of the regenerated biodiesel is introduced together with the stream conveyed in the second regeneration stage into the second gas scrubbing stage at the top of the gas scrubbing column.

The absorption can be carried out in a manner known per se by distribution of the scrubbing liquid and/or at the surface of the internals within the second scrubbing stage. At the bottom of the second scrubbing stage, i.e. in a middle region of the gas scrubbing column, an offtake tray is provided, with part of the scrubbing liquid in the form of biodiesel used in the second gas scrubbing stage going into the first gas scrubbing stage arranged underneath and thus being used further together with the substream of regenerated biodiesel fed in there for the absorption of the BTEX components.

The amount of biodiesel transferred from the second scrubbing stage into the first scrubbing stage usually corresponds to the first, more highly stripped substream of the regenerated biodiesel which is fed to the second gas scrubbing stage.

In a preferred embodiment having two gas scrubbing stages in one gas scrubbing column, the biodiesel enriched in the BTEX components and naphthalene is taken off at the bottom of the first gas scrubbing stage, i.e. at the bottom of the gas scrubbing column, and passed to regeneration.

According to a preferred development of the invention, the biodiesel taken off from the first gas scrubbing stage is, for the purpose of regeneration, firstly fed to a first regeneration stage in order to remove aromatic hydrocarbons from the biodiesel by stripping with steam, in particular a superheated steam having a temperature of more than 150° C. The regenerated biodiesel taken off from the first regeneration stage has, overall, only small proportions of BTEX components and can thus be used for the renewed BTEX scrub. Accordingly, the regenerated biodiesel taken off from the first regeneration stage is divided into the first substream and the second substream, with the second substream being reintroduced into the first scrubbing stage. Here, a desired temperature is usually merely set without a further treatment or change of the scrubbing liquid. In particular, it is advantageous to convey the second substream and the biodiesel enriched in aromatic hydrocarbons which has been taken off from the first scrubbing stage through a joint heat exchanger.

The first substream, on the other hand, is passed to a further regeneration in a second regeneration stage, in particular to achieve further removal of naphthalene from the biodiesel as scrubbing liquid. The branching-off of the first substream is advantageously carried out before the heat recovery by means of the heat exchanger described.

A particularly efficient process is obtained when the first regeneration stage is arranged above the second regeneration stage within a joint regeneration column. The steam, in particular a superheated steam having a temperature of more than 150° C., is then firstly introduced in its entirety into the second regeneration stage in a lower region of the regeneration column. Since only the first substream of the regenerated biodiesel is brought into contact with the entire steam in the second regeneration stage, the steam still has its maximum temperature and the proportion of aromatic hydrocarbons in the biodiesel which has previously been purified in the first gas scrubbing stage in total is low, naphthalene can be removed effectively in the second regeneration stage so that a considerable proportion of the residual concentration of naphthalene is separated off. It is thus possible to provide a highly stripped scrubbing liquid which has almost the properties of fresh biodiesel which, owing to its preparation from vegetable oils, is initially virtually free of naphthalene. As indicated above, the first substream is then fed to the second scrubbing stage.

The invention also provides an apparatus for carrying out the process, which has a first gas scrubbing stage and a second gas scrubbing stage, a first regeneration stage and a second regeneration stage, biodiesel as scrubbing liquid and a line and pumping system in order to convey the biodiesel in a circuit.

As already indicated above, the gas scrubbing stages can be arranged together in a gas scrubbing column and the regeneration stages can be arranged in a joint regeneration column.

Proceeding from a known process as per WO 2009/003 644 A1, the concentration of naphthalene can be considerably reduced at relatively low capital costs by means of the process of the invention.

In the case of the preferred combination of the two gas scrubbing stages in one gas scrubbing column and the two regeneration stages in one regeneration column, the removal of BTEX and naphthalene from the coke oven gas and the removal of the BTEX component and naphthalene from the biodiesel as scrubbing liquid are combined with one another in a particularly advantageous way, as a result of which the total outlay in teens of apparatus can be kept low.

The aromatic hydrocarbons discharged with the steam from the first regeneration stage can be separated off from the steam and utilized in a conventional way in downstream processes.

The biodiesel is obtained from vegetable oils. Typical starting materials are, for example, rapeseed oil, palm oil, sunflower oil and soybean oil, depending on the local circumstances, from which the corresponding methyl esters are formed. For the purposes of the invention, rapeseed oil methyl ester (RME) is particularly useful; this can be produced in large quantities in regions having a temperate climate and is commercially available.

The composition and the chemical and physical properties of biodiesel are described, for example, in the standards DIN EN14214 (November 2003) and ASTM D 6751-07A. The standards mentioned relate to the use of biodiesel as fuel. Against this background, variants of biodiesel which can deviate to a certain extent from the abovementioned standards can also be used in addition to the standardized types of biodiesel for use as scrubbing liquid for the absorption of aromatic hydrocarbons.

The invention is illustrated below with the aid of a drawing which depicts merely one working example. The single FIGURE schematically shows an apparatus for removing aromatic hydrocarbons from coke oven gas, in which biodiesel is conveyed in a circuit as scrubbing liquid.

Important parts of the plant for removing aromatic hydrocarbons from a coke oven gas COG are, as shown in the depicted working example, a gas scrubbing column 1 and a regeneration column 2. The coke oven gas COG is introduced via a feed line into a lower region of the gas scrubbing column 1 and flows through the gas scrubbing column 1 in a vertical direction, being brought into contact with biodiesel as scrubbing liquid, as a result of which aromatic hydrocarbons are absorbed by the biodiesel and thus separated off from the coke oven gas COG. The purified coke oven gas COG is then discharged through a discharge line in an upper region of the gas scrubbing column 1.

According to the invention, a first gas scrubbing stage 3 and, above this, a second gas scrubbing stage 4 are provided within the gas scrubbing column.

The biodiesel as scrubbing liquid enriched in aromatic hydrocarbons is taken off from the bottom of the first gas scrubbing stage 3, i.e. from the bottom of the gas scrubbing column 1, and fed to the regeneration column 2.

In order to make efficient removal of the aromatic hydrocarbons benzene, toluene, m-, p-, o-xylene and ethylbenzene (BTEX) possible in the first gas scrubbing stage 3, a temperature slightly above the gas entry temperature is preferably set in the case of biodiesel as scrubbing liquid in order to avoid condensation of the water present in the gas. The temperature here relates to a substream (second substream) of the biodiesel which is, after regeneration thereof, introduced directly into the first gas scrubbing stage 3.

To be able to separate the aromatic hydrocarbons from the bio diesel in the regeneration column 2, the temperature of the biodiesel as scrubbing liquid is increased, for which purpose the biodiesel taken off from the first gas scrubbing stage 3 is firstly passed through a heat exchanger 5 and then through a heating device 6. To regulate the temperature and streams, sensors for throughput control DK and for temperature control TK are provided in the line system. In addition, the fill levels in the regeneration column 2 can also be checked by sensors of a fill level control FK.

The entire biodiesel as scrubbing liquid is then introduced into a first regeneration stage 7 at a middle part of the regeneration column 2, with the biodiesel in the first regeneration stage 7 having a temperature of from about 170° C. to 190° C. The temperature range indicated is above the boiling points of the BTEX components, so that these are removed from the biodiesel as scrubbing liquid. Driving-off of the crude benzene by means of steam, in particular superheated steam having a temperature of more than 150° C., is particularly effective. Particular preference is given to a stripping temperature of from about 180° C. to 190° C.; the biodiesel as scrubbing liquid is also not vaporized or decomposed to a significant extent at such a temperature.

The biodiesel as scrubbing liquid which has been purified in the first regeneration stage 7 is subsequently divided into a first substream and a second substream. In the working example depicted, the scrubbing liquid is discharged at the bottom of the first regeneration stage 7 and divided outside the regeneration column 2 into the first substrearn and the second substream, with the first substream being fed to a first regeneration stage 8 for the purpose of further regeneration while the second substream is, after setting of a suitable temperature by means of the heat exchanger 5 and a cooler 9, reintroduced into the first gas scrubbing stage 3 in order to remove the BTEX components.

In a modification of the working examples shown, a division into the first substream and the second substream can also be effected at the bottom of the first regeneration stage 7 by only the second substream being discharged from the regeneration column 2 while the first substream goes directly into the second regeneration stage 8 for further purification.

As indicated above, the regeneration is effected by means of steam which is introduced through a steam feed line 10 into the second regeneration stage 8 in a lower region of the regeneration column 2. Since the entire steam is brought into contact only with the first substream of the total scrubbing liquid, this proportion of the scrubbing liquid has already been largely purified and the steam still has its original temperature, additional purification of the biodiesel can be achieved in the second regeneration stage 8, with naphthalene, in particular, being efficiently removed.

From the bottom of the second regeneration stage 8, i.e. from the bottom of the regeneration column 2, the more highly stripped first substream of the biodiesel is fed to the second gas scrubbing stage 4 and mixed with a substream of the biodiesel which is conveyed in a separate circuit 11 at the second gas scrubbing stage 4.

However, only part of the scrubbing liquid introduced is collected and conveyed in a circuit in the second gas scrubbing stage 4, while a further part goes into the first gas scrubbing stage 3 arranged underneath. The amount of biodiesel transferred from the second gas scrubbing stage 4 into the first gas scrubbing stage 1 corresponds here to the substream of the regenerated biodiesel which is fed in a highly stripped state to the second gas scrubbing stage 4.

As a result of such an open circuit at the second gas scrubbing stage 4, an accumulation of naphthalene is avoided by the discharge of enriched biodiesel into the first gas scrubbing stage 3 and the corresponding addition of highly stripped biodiesel as scrubbing liquid.

The BTEX components driven off from the biodiesel as scrubbing liquid and the naphthalene driven off from the scrubbing liquid leave the regeneration column 2 at the top thereof and can be recovered and utilized in a manner known per se. The improved removal of naphthalene from the coke oven gas COG compared to the prior art enables troublesome deposits in the downstream line system to be prevented.

The process parameters in the first gas scrubbing stage 3 are set so that the BTEX components can be effectively scrubbed out, while the parameters in the second gas scrubbing stage 4 are optimized for the removal of naphthalene. Owing to the different, in particular temperature-dependent equilibria, a higher temperature of the scrubbing liquid is preferably set for the removal of naphthalene in the second gas scrubbing stage 4 than in the first gas scrubbing stage 3.

Of course, a (partial) replacement of the scrubbing liquid or introduction of fresh biodiesel can be provided at a suitable place (not shown), even during operation.

1.-9. (canceled)

10. A method for removing aromatic hydrocarbons from coke oven gas, comprising:
contacting coke oven gas with biodiesel in a first gas scrubbing stage to separate off aromatic hydrocarbons from the coke oven gas by absorption into the biodiesel and thereby generate a purified coke oven gas;
removing the aromatic hydrocarbon enriched biodiesel from the first gas scrubbing stage;
heating the aromatic hydrocarbon enriched biodiesel;
treating the aromatic hydrocarbon enriched biodiesel with steam to at least partially strip the aromatic hydrocarbons from the biodiesel to produce a regenerated biodiesel;
cooling the regenerated biodiesel;
splitting the regenerated biodiesel into a first substream and a second substream, the first substream of regenerated biodiesel having more aromatic hydrocarbons removed than the second substream of regenerated biodiesel;
feeding the second substream of the cooled regenerated biodiesel back to the first gas scrubbing stage to be used as a scrubbing liquid for the first gas scrubbing stage;
feeding the first substream of the cooled regenerated biodiesel to a second gas scrubbing stage to be used as a scrubbing liquid for the second gas scrubbing stage; and
conveying the purified coke oven gas from the first gas scrubbing stage through a second gas scrubbing stage.

11. The method of claim 1, further comprising:
contacting, in the second gas scrubbing stage, the purified coke oven gas from the first gas scrubbing stage with the first substream of regenerated biodiesel to further separate off aromatic hydrocarbons from the coke oven gas by absorption into the regenerated biodiesel and thereby generate a further purified coke oven gas;
removing, from the second gas scrubbing stage, a portion of the first substream of regenerated biodiesel that was enriched with aromatic hydrocarbon in the second gas scrubbing stage; and
reintroducing back into the second gas scrubbing stage, the removed portion of the first substream of regenerated biodiesel.

12. The method of claim 11, further comprising:
in the second gas scrubbing stage, after said step of contacting the purified coke oven gas from the first gas scrubbing stage with the first substream of regenerated biodiesel, introducing, back into the first gas scrubbing stage for further enrichment with aromatic hydrocarbons, at least a portion of the first substream of regenerated biodiesel that passed through the second gas scrubbing stage.

13. The method of claim 12, wherein the amount of the regenerated biodiesel transferred from the second scrubbing stage back into the first scrubbing stage corresponds to the first substream of the regenerated biodiesel which is fed into the second gas scrubbing stage.

14. The method of claim 10, wherein said treating step is conducted in a first regeneration stage, and wherein said splitting step further comprises,
feeding the first substream of regenerated biodiesel into a second regeneration stage, and
treating, in the second regeneration stage, the first substream with steam to remove additional aromatic hydrocarbons from the first substream to yield a first substream of regenerated biodiesel having more aromatic hydrocarbons removed than the second substream.

15. The method of claim 14, wherein the treating steam used in the second regeneration stage is thereafter used as the treating steam in the first regeneration stage.

16. The method of claim 10, wherein the biodiesel consists substantially of rapeseed oil methyl ester.

17. An apparatus for removing aromatic hydrocarbons from coke oven gas, comprising:
a first gas scrubbing stage configured to permit coke oven gas to be passed there through and contacted with biodiesel therein, so as to remove aromatic hydrocarbons from the coke oven gas by absorption into the biodiesel;
a first regeneration stage in fluid communication with said first gas scrubbing stage and configured to place aromatic hydrocarbon laden biodiesel from said first gas scrubbing stage in contact with steam to remove at least a portion of the aromatic hydrocarbons from the biodiesel and produce regenerated biodiesel;
a second regeneration stage in fluid communication with said first regeneration stage configured to further remove additional aromatic hydrocarbons from at least a substream of the biodiesel;
a second gas scrubbing stage in fluid communication with each of said second regeneration stage and said first gas scrubbing stage and configured to permit coke oven gas from said first gas scrubbing stage to be passed there through and further scrubbed of residual aromatic hydrocarbons therein by the substream of biodiesel; and
a pumping system in fluid communication with each of said first and second regeneration stages, and said first and second gas scrubbing stages, wherein said pumping system is configured to circulate the biodiesel throughout the system to be used as an aromatic hydrocarbon scrubbing liquid in at least one of said first and second gas scrubbing stages.

18. The apparatus of claim 17, wherein said second gas scrubbing stage is disposed above said first gas scrubbing stage in a joint gas scrubbing column, and said first regeneration stage is disposed above said second regeneration stage in a joint regeneration column.

19. The apparatus of claim 18, further comprising:
a coke oven gas feed line disposed in a lower region of said gas scrubbing column and configured to permit entry of aromatic hydrocarbon laden coke oven gas into said gas scrubbing column;
a purified coke oven gas discharge line disposed in an upper region of said gas scrubbing column and configured to permit purified coke oven gas that has been at least partially stripped of aromatic hydrocarbons to be removed from said gas scrubbing column;
a steam feed line disposed in a lower region of said, regeneration column and configured to permit entry therein of steam used to strip at least a portion of aromatic hydrocarbons from the aromatic hydrocarbon laden biodiesel scrubbing liquid; and
a steam discharge line disposed in an upper region of said regeneration column and configured to permit the exit from said regeneration column of the steam and the aromatic hydrocarbons that have been stripped out of the biodiesel.
